(19) United States
(12) Patent Application Publication
(10) Pub. No.: US 2026/0322408 A1
(43) Pub. Date: Oct. 15, 2026

(54) RADIATION HARDENED NETWORKING DEVICE WITH SOFTWARE DEFINED RADIO

(71) Applicant: Axiom Space, Inc., Houston, TX (US)

(72) Inventors: Nancy Angelica Ladin, Houston, TX (US); Joshua Remington Horejs, League City, TX (US)

(21) Appl. No.: 19/178,450

(22) Filed: Apr. 14, 2025

(51) Int. Cl. H04B 1/00; H04B 1/38; H04W 84/12

(52) U.S. Cl. CPC H04B 1/0003; H04B 1/38; H04W 84/12

(57) ABSTRACT

This disclosure is directed to radio systems of spacesuits or space exploration vehicles that include one or more radiation hardened computing and radio devices. A spacesuit or a space exploration vehicle may include an electronic system including the radiation hardened computing and radio devices and one or more antennas. A radiation hardened computing and radio device may include a radiation hardened programmable logic device (PLD) implementing one or more software-defined radios (SDRs). The programmable logic device may be radiation hardened to withstand (e.g., tolerate particle effects of) a predefined amount of radiation. As such, the spacesuit or space exploration vehicle may communicate data via the antennas using the SDR implemented by the programmable logic device in terrestrial environment, low earth orbit, and/or lunar or planetary surface, among other possibilities.

### BACKGROUND

The present disclosure generally relates to electronic systems of spacesuits and/or other devices suitable for use in space. A spacesuit may communicate data by transmitting and/or receiving radio frequency (RF) signals. The spacesuit may include antennas and electronic circuits to communicate the data by transmitting and/or receiving the RF signals. For example, the spacesuit may communicate with other spacesuits, space stations, spacecrafts, lunar terrain vehicles, and/or satellites, among other things.

An astronaut may engage in extravehicular activities when outfitted in the spacesuit. As such, the spacesuit may operate in environments having higher radiation particle and/or electromagnetic radiations compared to radiations near the surface of the earth. For example, a spacesuit may operate in various orbits in space that have higher proton or ion radiations compared to terrestrial environments. If not compensated for, in some cases, electronic circuitry of the spacesuit may become susceptible to disruptions caused by such radiations. In specific cases, a disruption of the electronic circuitry may interfere with operations of the spacesuit. Accordingly, reducing susceptibility of the electronic circuitry of the spacesuit to such disruptions may be desired.

### SUMMARY

A summary of certain embodiments disclosed here is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A radiation hardened computing and radio device (e.g., a mission computer assembly) suitable for a spacesuit or a space exploration vehicle is described. The radiation hardened computing and radio device may couple to an accessory of the spacesuit and/or the space exploration vehicle. The radiation hardened computing and radio device may also couple to an antenna of the spacesuit and/or the space exploration vehicle. The radiation hardened computing and radio device may implement a software-defined radio (SDR) that may process radio frequency (RF) signals received and transmitted by the antenna.

In some embodiments, the radiation hardened computing and radio device may input RF signals received by the antenna. The RF signals may include Wi-Fi RF signals, UHF RF signals, cellular RF signals, among other possibilities. The radiation hardened computing and radio device may generate data (e.g., packetized data) based on the received RF signals. For example, the radiation hardened computing and radio device may generate the data with a protocol of the accessory such that the accessory may receive the data. In alternative or additional embodiments, the radiation hardened computing and radio device may input data (e.g., packetized data) having a first format from the accessory. The radiation hardened computing and radio device may generate RF signals based on the received data.

The radiation hardened computing and radio device may be radiation hardened to withstand (e.g., tolerate particle effects of) a predefined amount of radiation while remaining operational. For example, the radiation hardened computing and radio device may be radiation hardened to withstand radiation amounts higher than terrestrial proton and ion radiation doses. In some embodiments, the radiation hardened computing and radio device may be radiation hardened to withstand radiation amounts higher than that other Wi-Fi or cellular device chips are able to withstand while remaining operational. Accordingly, the spacesuit and/or the space exploration vehicle may communicate data in environments with higher amount of radiation compared to other Wi-Fi or cellular device chips.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a diagram of a spacesuit, according to embodiments of the present disclosure;

FIG. 2 is a diagram of a space exploration vehicle, according to embodiments of the present disclosure;

FIG. 3 is a block diagram of a computing and radio device of the spacesuit of FIG. 1 and/or the space exploration vehicle of FIG. 2, according to embodiments of the present disclosure;

FIG. 4 is a block diagram of an electronic system of the spacesuit of FIG. 1 and/or the space exploration vehicle of FIG. 2 including the computing and radio device of FIG. 3, according to embodiments of the present disclosure;

FIG. 5 is a block diagram of the electronic system of FIG. 4 including multiple processing blocks, accessories, and communication interfaces and drivers, according to embodiments of the present disclosure;

FIG. 6 is a block diagram of a carrier circuit board (e.g., a mezzanine board) of the spacesuit of FIG. 1 and/or the space exploration vehicle of FIG. 2 including the computing and radio device of FIG. 3, according to embodiments of the present disclosure; and

FIG. 7 is a process for reception and processing of Wi-Fi signals by Wi-Fi antennas and a programmable logic device of the spacesuit of FIG. 1 and/or the space exploration vehicle of FIG. 2, according to embodiments of the present disclosure; and

FIG. 8 is a process for processing and transmission of Wi-Fi signals by the programmable logic device and the Wi-Fi antennas of the spacesuit of FIG. 1 and/or the space exploration vehicle of FIG. 2, according to embodiments of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided here, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to radio systems of spacesuits, space exploration vehicles, and/or other devices suitable for use in space. A spacesuit and/or a space exploration vehicle may include an electronic system including a radiation hardened computing and radio device. The computing and radio device may include one or more radiation hardened programmable logic devices (PLDs) and one or more antennas (e.g., Wi-Fi antennas). Each of the programmable logic devices may implement one or more software-defined radios (SDRs). Moreover, each of the SDRs may include circuitry (e.g., implemented circuitry) associated with Wi-Fi signals, ultra-high frequency (UHF) signals, cellular signals, or any combination thereof, among other possibilities. The spacesuit and/or the space exploration vehicle may communicate data via the antennas by the SDR implemented by the programmable logic device.

At least a portion of the computing and radio device may be radiation hardened to withstand (e.g., tolerate particle effects of) a predefined amount of radiation while remaining operational. In some embodiments, the programmable logic device may be radiation hardened to withstand (e.g., tolerate particle effects of) the predefined amount of radiation while remaining operational. For example, the programmable logic device may be radiation hardened to withstand radiation amounts higher than terrestrial proton and ion radiation doses. In some embodiments, the programmable logic device may be radiation hardened to withstand radiation amounts higher than that other Wi-Fi or cellular device chips are able to withstand while remaining operational. Accordingly, the spacesuit and/or the space exploration vehicle may communicate data in terrestrial environment, low earth orbit, and/or lunar or planetary surface, among other possibilities, as will be appreciated.

Implementing the SDR by the radiation hardened programmable logic device may improve flexibility and/or reliability of the computing and radio device and/or the electronic system of the spacesuit and/or the space exploration vehicle. In some cases, implementing the SDR by the radiation hardened programmable logic device may improve processing speed and/or reduce electrical power consumption of the computing and radio device and/or the electronic system in harsher conditions. In some embodiments, the computing and radio device may dynamically define, update, and/or reprogram the SDR based on programmability of the programmable logic device. Accordingly, in some cases, implementing the SDR by the radiation hardened programmable logic device may improve reliability of the computing and radio device and/or the electronic system in case of single-event disruptions.

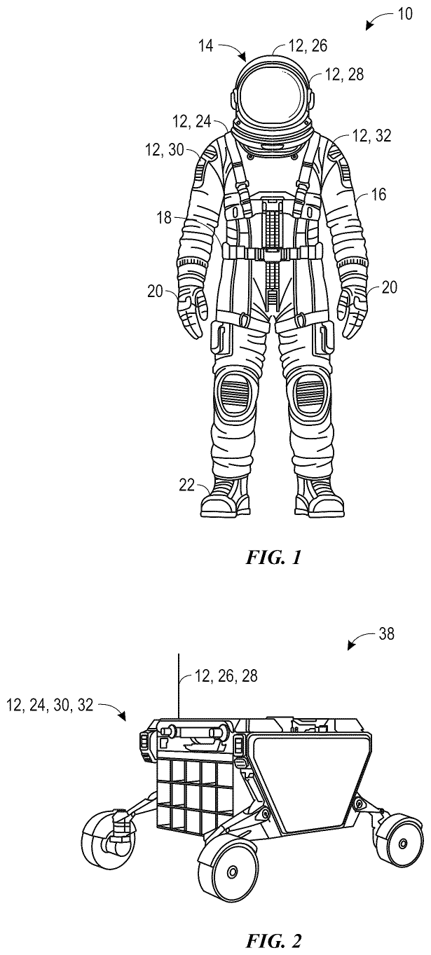

FIG. 1 is a diagram of a spacesuit 10, according to embodiments of the present disclosure. The spacesuit 10 may include an electronic system 12, a helmet 14, inner and/or outer garments 16, a belt 18, gloves 20, and boots 22. It should be appreciated that in alternative or additional embodiments, the spacesuit 10 may include alternative or additional components and/or may omit one or more of the aforementioned components. In some embodiments, the spacesuit 10 may include combined components that may include two or more integrated components.

In the depicted embodiment, the electronic system 12 may include a computing and radio device 24, UHF and/or cellular antennas 26, Wi-Fi antennas 28, accessories 30, and a power supply 32. In alternative or additional embodiments, the electronic system 12 may include additional and/or different circuitry and/or components. The computing and radio device 24 may include one or more transceivers and processing circuitry including programmable logic devices. In some embodiments, the computing and radio device 24 may include one or more radiation hardened components.

The UHF and/or cellular antennas 26 may include one or more UHF antennas 26, one or more cellular antennas 26, or both. Each UHF and/or cellular antenna 26 may transmit and receive signals (e.g., analog signals) having a frequency within a first frequency range. Each UHF and/or cellular antenna 26 may transmit and receive signals having a frequency equal to or below 1 mega-hertz (MHz), between 1 MHz and 1 giga-hertz (GHz), and/or equal to or above 1 GHz. Moreover, each UHF and/or cellular antenna 26 may transmit and/or receive signals having a frequency range within a channel bandwidth of 0.1 MHz, 0.3 MHz, 1 MHz, 3 MHz, and so on, among other possibilities.

By way of example, each UHF and/or cellular antenna 26 may transmit and receive signals having a frequency range of 400-425 MHz, 462-468 MHz, 462-487 MHz, 764-806 MHz, and/or 1.559-1.610 GHz, among other possibilities. In specific cases, a UHF and/or cellular antenna 26 may transmit and receive signals having a frequency range of 757-758 MHz, 769-775 MHz, 775-776 MHz, 776-788 MHz, 787-788 MHz, 763-775 MHz, 793-805 MHz, and/or 799-805 MHz within the frequency range of 764-806 MHz mentioned above. Alternatively or additionally, the UHF and/or cellular antennas 26 may include other antennas transmitting and receiving signals having a frequency within a different frequency range and/or bandwidth.

The Wi-Fi antennas 28 may include one or more Wi-Fi antennas 28. Each Wi-Fi antenna 28 may transmit and receive signals having a frequency within a second frequency range. For example, each Wi-Fi antenna 28 may transmit and receive signals having a frequency between 0.5-2 giga-hertz (GHz), 0.7-2.4 GHz, 2-4 GHz, 2.4-5 GHz, 2.5-6 GHz, 6-60 GHz, and so on. The computing and radio device 24 may be coupled to one or more of the UHF and/or cellular antennas 26 and one or more of the Wi-Fi antennas 28. The computing and radio device 24 may communicate data by transmitting and/or receiving radio frequency (RF) signals via the UHF and/or cellular antennas 26 and/or the Wi-Fi antennas 28. As such, the spacesuit 10 may communicate with one or more electronic devices having communication circuitry, such as one or more other spacesuits, among other things, by the antennas 26 and 28.

The accessories 30 may include cameras, displays, graphical display boards, memory devices, data offload devices, redundant circuitry, speakers, microphones, communication hardlines, sensors (e.g., biological sensors, etc.) or any combination thereof, among other things. The computing and radio device 24 may be coupled to one or more of the accessories 30. The computing and radio device 24 may output instructions to one or more of the accessories 30, may process data received from one or more of the accessories 30, or both.

In some cases, the computing and radio device 24 may output the instructions to one or more of the accessories 30 based on transmitting and/or receiving the radio frequency signals via the UHF and/or cellular antennas 26 and/or the Wi-Fi antennas 28. The computing and radio device 24 may transmit and/or receive the radio frequency signals via the UHF and/or cellular antennas 26 and/or the Wi-Fi antennas 28 based on the data received from one or more of the accessories 30. For example, the computing and radio device 24 may output data generated and/or received from one or more of the accessories 30. Alternatively or additionally, the computing and radio device 24 may generate the transmission data or otherwise process/pre-process the data received from one or more of the accessories 30 before transmission by one or more of the antennas 26 and/or 28.

The power supply 32 may output electrical power to the computing and radio device 24 and/or one or more of the accessories 30. The computing and radio device 24 may output data for transmission by one or more of the antennas 26 and/or 28 and/or receive data received by one or more of the antennas 26 and/or 28 based on receiving the electrical power. In some embodiments, the computing and radio device 24 may include a power distribution circuit coupled to the power supply 32. The power distribution circuit may provide a portion of the electrical power of the power supply 32 to the computing and radio device 24, one or more of the accessories 30, among other possibilities.

With the foregoing in mind, an astronaut outfitted in the spacesuit 10 may engage in space exploration activities, for example, in space environments. The space exploration activities may include, but may not be limited to, extravehicular activities, spacewalks, and lunar or planetary surface exploration, among other possibilities. Space environments may have high radiations having particle and/or electromagnetic radiations higher than radiations near the surface of the earth. For example, the spacesuit 10 may operate in various orbits in space that have higher proton and ion radiation doses compared to proton and ion radiation amounts near the surface of the earth.

If not accounted for, in some cases, the high radiations may disrupt an operation of the electronic system 12. In some embodiments, the computing and radio device 24 may include radiation hardened components to withstand (e.g., tolerate particle effects of) radiation amounts higher than terrestrial proton and ion radiation doses. For example, the computing and radio device 24 may include radiation hardened components to withstand radiation amounts associated with space exploration activities. Accordingly, the spacesuit 10 may communicate data in terrestrial environment and during space exploration activities, as will be appreciated.

FIG. 2 is a diagram of a space exploration vehicle 38, according to embodiments of the present disclosure. The space exploration vehicle 38 may engage in space exploration activities, for example, in space environments. The space exploration vehicle 38 may include a lunar terrain, an autonomous vehicle (e.g., a rover), or any other viable vehicular device suited for space exploration activities including, but not limited to, lunar or planetary surface exploration. For example, the space exploration vehicle 38 may operate in various orbits (e.g., type of orbits) in space that have higher proton and ion radiation doses compared to proton and ion radiation amounts near the surface of the earth.

In the depicted embodiment, the space exploration vehicle 38 may include the electronic system 12 including the computing and radio device 24, the ultra-high frequency (UHF) and/or cellular antennas 26, the Wi-Fi antennas 28, the accessories 30, and the power supply 32. In alternative or additional embodiments, the electronic system 12 may include additional and/or different circuitry and/or components.

As discussed above, the computing and radio device 24 may include radiation hardened components to withstand (e.g., tolerate particle effects of) radiation amounts higher than terrestrial proton and ion radiation doses. For example, the computing and radio device 24 may include radiation hardened components to withstand radiation amounts associated with space exploration activities. Accordingly, the spacesuit 10 may communicate data in terrestrial environment and during space exploration activities.

It should be appreciated that in alternative or additional embodiments, the space exploration vehicle 38 may include alternative or additional components and/or may omit one or more of the shown components. For example, the space exploration vehicle 38 may include wheel and/or tracks, among other possibilities. In some embodiments, the space exploration vehicle 38 may include combined components that may include two or more integrated components.

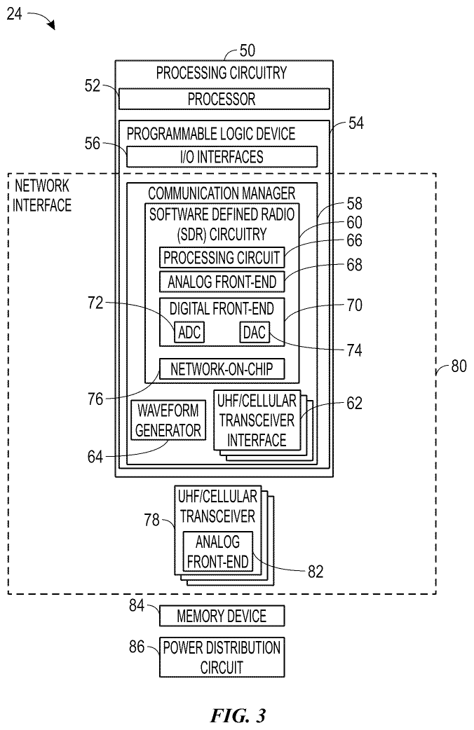

FIG. 3 is a block diagram of the computing and radio device 24, according to embodiments of the present disclosure. In some embodiments, the computing and radio device 24 may include an electronic device disposed on a carrier circuit board (e.g., a mezzanine board). In different embodiments, the computing and radio device 24 may include additional and/or different electronic devices, carrier circuit boards, and/or components. The computing and radio device 24 may also include one or more radiation hardened components, as will be appreciated.

The computing and radio device 24 may include processing circuitry 50 including a processor 52 and a programmable logic device 54. In some embodiments, the computing and radio device 24 may include multiple processors 52 and/or processor cores. For example, the multiple processors 52 may include different processor types such as central processing units and graphical processing units that implement different types of processing. Alternative or additionally, the processor 52 may include multiple processor cores. In some cases, the processor 52 may perform various operations such as automated suit control data management and/or graphical display processing, among other things. In specific embodiments, the computing and radio device 24 may omit the processor 52.

The processor 52 may be coupled to and may communicate with the programmable logic device 54 and/or one or more of the accessories 30 mentioned above with respect to FIG. 1 and described in more details below. In some cases, the processor 52 and the programmable logic device 54 may perform operations (e.g., processes) in parallel. The computing and radio device 24 may also include non-transitory computer readable media storing instructions that may cause the processor 52, the programmable logic device 54, or both to perform various operations (e.g., processes).

The programmable logic device 54 may include a field programmable gate array (FPGA) and/or an application-specific integrated circuit (ASIC) like a programmable ASIC among other possibilities. In some embodiments, the programmable logic device 54 may include a fabric including one or multiple intellectual property (IP) cores, among other things. Each IP core may include a portion of logic blocks of the programmable logic device 54. The fabric of the programmable logic device 54 may include (e.g., implement) input/output (I/O) interfaces 56 and a communication manager 58. The I/O interfaces 56 and the communication manager 58 may each include one or more circuits implemented on one or more of the IP cores of the programmable logic device 54. Alternatively or additionally, each IP core may implement one or more of the circuits associated with the I/O interfaces 56 and the communication manager 58.

The I/O interfaces 56 may include a number of separate or combined interface circuits that may couple to the accessories 30 of the spacesuit 10 and/or the space exploration vehicle 38 mentioned above. The I/O interfaces 56 may facilitate communication (e.g., transmission and reception) of data between the accessories 30 and the programmable logic device 54. The accessories 30 of the spacesuit 10 may be described in more details below. In some embodiments, a portion of the I/O interfaces 56 and/or the communication manager 58 may be disposed outside the fabric of the programmable logic device 54. In other embodiments, different portions of the I/O interfaces 56 and the communication manager 58 may be radiation hardened and/or implemented on the logic blocks of the fabric of the programmable logic device 54.

For example, the programmable logic device 54 may implement the I/O interfaces 56 and the communication manager 58 based on a configuration bitstream and in response to activation of the communication manager 58, the programmable logic device 54, and/or the processing circuitry 50. The configuration bitstream may be stored on a memory device coupled to or included with the programmable logic device 54. For example, the configuration bitstream may correspond to the instructions stored on the non-transitory computer readable media to cause the programmable logic device 54 to perform the various operations (e.g., processes). Likewise, instructions may be stored to cause the processor 52 to perform certain actions. Alternatively or additionally, the programmable logic device 54 may implement the I/O interfaces 56 and/or the communication manager 58 based on the configuration bitstream and in response to receiving instructions from the processor 52, among other possibilities.

The communication manager 58 may generate data packets, up-convert and/or down-convert transmission signals and/or received signals, convert digital data to analog signals, convert analog signals to digital data, and/or route data between various components of the programmable logic device 54, among other things, based on Wi-Fi protocols. In the depicted embodiment, the communication manager 58 may include SDR 60 (e.g., Wi-Fi SDR) and UHF/cellular transceiver interfaces 62. In different embodiments, a single IP core or multiple IP cores of the programmable logic device 54 may implement at least a portion of the SDR 60, at least a portion of the UHF/cellular transceiver interfaces 62, a waveform generator 64, or any combination of both. Although the programmable logic device 54 includes the waveform generator 64, it should be appreciated that in alternative or additional embodiments at least a portion of the waveform generator 64 may be disposed outside of the programmable logic device 54. For example, at least a portion of the waveform generator 64 may be disposed on dedicated circuitry of the computing and radio device 24 outside of the programmable logic device 54.

The SDR 60 may include a processing circuit 66 (e.g., a signal processing circuit 66), an analog front-end 68, a digital front-end 70, and a network-on-chip (NOC) 76 implemented on the programmable logic device 54. The processing circuit 66 may process transmission data and/or received data based on Wi-Fi communication protocols (e.g., Institute of Electrical and Electronics Engineers (IEEE) 802 standards, IEEE 802.11). For example, the processing circuit 66 may input data from the processor 52, the digital front-end 70, a memory device of the computing and radio device 24, and/or one or more of the accessories 30 of the electronic system 12 disposed on the spacesuit 10 and/or the space exploration vehicle 38 discussed above. In some embodiments, the processing circuit 66 and the processor 52 may operate in parallel. In some cases, the processing circuit 66 and the processor 52 may each perform a portion of the processing of the transmission data and/or the received data based on the Wi-Fi protocols.

Processing the transmission data and/or the received data may include generating data packets based on the Wi-Fi protocols, up-converting and/or down-converting the transmission signals and/or the received signals, or any combination thereof, among other things. In some cases, the processing circuit 66 may output the data packets to the analog front-end 68 and/or the digital front-end 70 for transmission by the Wi-Fi antennas 28. Alternatively or additionally, the processing circuit 66 may output the data packets to one or more of the accessories 30 of the electronic system 12 disposed on the spacesuit 10 and/or the space exploration vehicle 38 discussed above. The processing circuit 66 may include routers, phase-locked loops, mixers, filters, amplifiers, modulators, demodulators, or any combination thereof, among other things, to generate the data packets. In some embodiments, the processing circuit 66 may operate at a baseband frequency rate.

The analog front-end 68 may couple to the processing circuit 66 and the Wi-Fi antennas 28. In some embodiments, the analog front-end 68 may couple to the processing circuit 66 and the Wi-Fi antennas 28 via the NOC 76. The NOC 76 may include circuitry, such as various logic blocks, to route data between various components of the programmable logic device 54. The analog front-end 68 may input the transmission signals from the processing circuit 66, adjust the transmission signals based on a Wi-Fi standard (e.g., the IEEE 802 standards), and output the transmission signals, as adjusted, to the Wi-Fi antennas 28 for transmission. In some cases, the analog front-end 68 may adjust a gain of the transmission signals. In specific cases, the analog front-end 68 may match (e.g., nearly match, approximately match) an input/output impedance of the Wi-Fi antennas 28 with an input/output impedance of the processing circuit 66, digital front-end 70, or both.

In some embodiments, the analog front-end 68 may include an intermediate frequency (IF) front-end to up-convert and/or down-convert the transmission signals and/or the received signals. As mentioned above, a transmission frequency and/or a reception frequency of the Wi-Fi antennas 28 may be in a Wi-Fi frequency range of 0.5-2 GHz, 0.7-2.4 GHz, 2-4 GHz, 2.4-5 GHz, 2.5-6 GHz, 6-60 GHz, and so on. In some embodiments, the operating frequency (e.g., the baseband frequency rate) associated with the programmable logic device 54, the communication manager 58, the SDR 60, and/or the processing circuit 66 may be

Between 50-100 Kilo-hertz (KHz), 50 KHz-1 MHz, 0.5-10 MHz, 9-20 MHz, 19-100 MHz, 90-500 MHz, and so on.

The processing circuit 66 may include circuitry operating at the baseband frequency rate lower than the transmission frequency and/or the reception frequency of the Wi-Fi antennas 28. For example, the analog front-end 68 may up-convert (e.g., adjust) the transmission signals for transmission by the Wi-Fi antennas 28. The analog front-end 68 may include routers, phase-locked loops, mixers, filters, amplifiers, modulators, demodulators, or any combination thereof, among other things, to adjust the transmission signals based on the Wi-Fi standard.

The analog front-end 68 may input the received signals of the Wi-Fi antennas 28. The analog front-end 68 may adjust the received signals based on the Wi-Fi standard and output the received signals, as adjusted, to the processing circuit 66 for reception. For example, the analog front-end 68 may down-convert (e.g., adjust) the received signals for reception by the processing circuit 66 operating at the baseband frequency rate. The analog front-end 68 may adjust the received signals based on the Wi-Fi standard by the routers, the phase-locked loops, the mixers, the filters, the amplifiers, the modulators, the demodulators, or any combination thereof, among other things. In some cases, the analog front-end 68 may adjust a gain of the received signals.

The digital front-end 70 may couple to the processor 52, the I/O interfaces 56, the processing circuit 66, and/or the analog front-end 68 via the NOC 76. The digital front-end 70 may include analog-to-digital converters (ADCs) 72, digital-to-analog converters (DACs) 74, and/or harmonic balance circuits (HBn), among other things. For example, the digital front-end 70 may generate data based on inputting the received signals (e.g., the analog signals) of the Wi-Fi antennas 28. In some cases, the analog front-end 68 may adjust a gain of input signals. The digital front-end 70 may output the generated data to the processing circuit 66, the processor 52, the I/O interfaces 56, among other things. As such, the digital front-end 70 may generate reception Wi-Fi data for processing by the processing circuit 66 based on the received Wi-Fi signals of the Wi-Fi antennas 28.

In some embodiments, the digital front-end 70 may input transmission data corresponding to the transmission signals (e.g., the analog signals). For example, the digital front-end 70 may input the transmission data from the processing circuit 66, the processor 52, and/or one or more of the accessories 30. In such embodiments, the digital front-end 70 may adjust the transmission data based on the Wi-Fi standard, and output the transmission data, as adjusted, to the analog front-end 68 for transmission by the Wi-Fi antennas 28. Accordingly, the digital front-end 70 may generate transmission Wi-Fi data for transmission by the Wi-Fi antennas 28 based on the transmission Wi-Fi signals of the processing circuit 66.

In some embodiments, the communication manager 58 may include UHF/cellular transceiver interfaces 62. The UHF/cellular transceiver interfaces 62 may couple to UHF/cellular transceivers 78 to transmit and/or receive UHF signals, cellular signals, and/or signals having any viable frequency and/or based on any other viable communication protocol. In some embodiments, the UHF/cellular transceiver interfaces 62 may include circuitry implemented on the fabric of the programmable logic device 54. For example, the UHF/cellular transceiver interfaces 62 may include any combination of routers, phase-locked loops, mixers, filters, amplifiers, modulators, and demodulators, among other thing, to transmit and/or receive UHF and/or cellular signals, among other signals.

In different embodiments, the computing and radio device 24 may include a different number of the UHF/cellular transceivers 78 coupled to the UHF and/or cellular antennas 26 of the electronic system 12, the spacesuit 10, and/or the space exploration vehicle 38. In some embodiments, the UHF/cellular transceivers 78 may also couple to the UHF/cellular transceiver interfaces 62 to communicate at least a portion of the transmission signals and the received signals. For example, the computing and radio device 24 may include a number of the UHF/cellular transceivers 78 based on a number of the UHF/cellular transceiver interfaces 62, a number of the UHF and/or cellular antennas 26, or both. In some cases, the waveform generator 64 may be coupled to the SDR 60 and/or the UHF/cellular transceiver interfaces 62. Moreover, the waveform generator 64 may generate at least a portion of the transmission signals.

The communication manager 58, including the SDR 60, the UHF/cellular transceiver interfaces 62, and/or the waveform generator 64, may form a network interface 80 with the UHF/cellular transceivers 78. The network interface 80 may process and/or adjust data and signals between the programmable logic device 54, the processor 52, and/or the accessories 30, the antennas 26, and/or 28 of the electronic system 12 disposed on the spacesuit 10 and/or the space exploration vehicle 38 discussed above. Accordingly, the computing and radio device 24 may transmit and/or receive signals via the antennas 26 and/or 28 using the network interface 80.

For example, the UHF/cellular transceivers 78 may each include an analog front-end 82 coupled to the UHF and/or cellular antennas 26. As discussed above, the UHF and/or cellular antennas 26 may include multiple antennas transmitting and receiving signals having a frequency within a UHF and/or cellular frequency range or other frequency ranges. As such, the analog front-end 82 may include routers, phase-locked loops, mixers, filters, amplifiers, modulators, demodulators, or any combination thereof, among other things. In some cases, the analog front-end 82 may up-convert and/or down-convert (e.g., adjust) the received signals and/or the transmission signals of the UHF and/or cellular antennas 26. Accordingly, the analog front-end 82 may adjust received signals and/or transmission signals of the UHF and/or cellular antennas 26 based on the UHF/cellular standard, among other possibilities.

The UHF/cellular transceivers 78 may each include circuitry to transmit and/or receive signals having a frequency within the UHF and/or cellular frequency range or the other frequency ranges. For example, each of the UHF/cellular transceivers 78 may transmit and/or receive signals having a frequency within a portion of the transmission and/or reception frequency range of the computing and radio device 24. In specific cases, one or more of the UHF/cellular transceivers 78 may be coupled to one or more of the UHF and/or cellular antennas 26. Accordingly, a communication frequency range of the computing and radio device 24 may be at least partially based on a transmission and/or reception frequency range of the UHF and/or cellular antennas 26. Similarly, the communication frequency range of the computing and radio device 24 may be at least partially based on a transmission and/or reception frequency range of the Wi-Fi antennas 28 discussed above.

The computing and radio device 24 may include a memory device 84. The memory device 84 may be coupled to and may communicate with the programmable logic device 54 and/or one or more of the accessories 30 mentioned above with respect to FIG. 1 and described in more details below. The memory device 84 may include a volatile and/or non-volatile storage. In some embodiments, the programmable logic device 54 may include at least a portion of the memory device 84. In specific embodiments, the memory device 84 may include the non-transitory computer readable storing the instructions that may cause the processor 52, the programmable logic device 54, or both to perform the various operations (e.g., processes).

The memory device 84 may store and output information and data based on receiving instructions from the programmable logic device 54 (e.g., the processing circuit 66), the processor 52, or any other viable component. For example, the programmable logic device 54 and/or the processor 52 may store at least a portion of the data received from the accessories 30 and/or the antennas 26 and/or 28 before processing and/or transmission. Alternatively or additionally, the programmable logic device 54 and/or the processor 52 may store processed data before transmission to the accessories 30 and/or the antennas 26 and/or 28.

In some embodiments, the memory device 84 may store the configuration bitstream describing the I/O interfaces 56 and the communication manager 58. As such, the programmable logic device 54 may implement the I/O interfaces 56 and the communication manager 58 based on accessing the memory device 84 storing the configuration bitstream. As mentioned above, the programmable logic device 54 may implement the I/O interfaces 56 and the communication manager 58 based on activation of the communication manager 58, the programmable logic device 54, and/or the processing circuitry 50, receiving instructions from the processor 52, or both, among other possibilities.

The computing and radio device 24 may include a power distribution circuit 86. The power distribution circuit 86 may be coupled to a power supply to receive electrical current. The power distribution circuit 86 may be coupled to the processor 52, the programmable logic device 54, the UHF/cellular transceivers 78, and/or the memory device 84. The power distribution circuit 86 may distribute the electrical power to the components of the computing and radio device 24. Accordingly, the processor 52, the programmable logic device 54, the UHF/cellular transceivers 78, and/or the memory device 84 may perform the operations described above based on the electrical power. It should be appreciated that in alternative or additional embodiments, the computing and radio device 24 may include alternative components, additional components, and/or omit one or more of the aforementioned components.

With the foregoing in mind, the computing and radio device 24, the programmable logic device 54, or at least a portion of the computing and radio device 24 and/or the programmable logic device 54, may be radiation hardened when compared to a Wi-Fi integrated circuit (e.g., an immutable Wi-Fi integrated circuit, a static Wi-Fi integrated circuit). The computing and radio device 24 and/or the programmable logic device 54 may be radiation hardened to withstand (e.g., tolerate particle effects of) a predetermined amount of radiation and remain operational. In some embodiments, the computing and radio device 24 and/or the programmable logic device 54 may have a non-destructive Single Event Functional Interrupt (SEFI) rate less than 0.01, 0.001, 0.0003, 0.00001, 0.000005, 0.000001, 0.0000005, 0.0000001, and so on, among other possibilities, per hour. In alternative or additional embodiments, the computing and radio device 24 and/or the programmable logic device 54 may have a non-destructive Single Event Functional Interrupt (SEFI) rate less than 0.1, 0.01, 0.003, 0.001, 0.0005, 0.00012, 0.00007, 0.000012, and so on, among other possibilities, per day. The non-destructive Single Event Functional Interrupt (SEFI) rates may indicate a threshold number for non-destructive interruptions of the computing and radio device 24 and/or the programmable logic device 54. The interruptions may be caused by various things including but not limited to the radiation.

In some embodiments, the computing and radio device 24 and/or the programmable logic device 54 may have a destructive Single Event Effect (SEE) Linear Energy Transfer (LET) threshold higher than 10 mega-electronvolts energy (MeV) per centimeters square unit area (cm²) per milligram mass (mg), 25 MeVcm²mg, 31 MeVcm²mg, 37 MeVcm²mg, 52 MeVcm²mg, 60 MeVcm²mg, 70 MeVcm²mg, and so on, among other possibilities. The Single Event Effect (SEE) Linear Energy Transfer (LET) threshold may indicate a threshold for energy transferred from radiations that may cause dysfunction (e.g., permanent dysfunction) of the programmable logic device 54 and/or the computing and radio device 24.

In some embodiments, the computing and radio device 24 and/or the programmable logic device 54 may tolerate particle effects of (e.g., absorb) a total and/or cumulative amount (e.g., dose) of less than 0.5 Kilo radiation absorbed dose (Krads), 1.1 Krads, 2 Krads, 2.23 Krads, 2.3 Krads, 2.5 Krads, 3 Krads, 4.6 Krads, 7.9 Krads, and so on, among other possibilities, at each time. The computing and radio device 24 and/or the programmable logic device 54 may absorb a total and/or cumulative amount (e.g., dose) of less than 0.5 Krads, 1.1 Krads, 15 Krads, 22.4 Krads, 27.8 Krads, 31.132 Krads, 37.12 Krads, 43.56 Krads, 52.87 Krads, and so on, among other possibilities, over a time period of 1 year, 4 years, 7.5 years, 15 years, 18 years, 25 years, among other possibilities.

Although the non-destructive Single Event Functional Interrupt (SEFI) rates, the destructive Single Event Effect (SEE) Linear Energy Transfer (LET) threshold, and the total absorption rates are described with respect to the computing and radio device 24 and/or the programmable logic device 54, it should be appreciated that in some embodiments, such rates and/or thresholds may also apply to the processor 52 and/or a portion and/or the entirety of the computing and radio device 24 and/or the electronic system 12. In some embodiments, the non-destructive Single Event Functional Interrupt (SEFI) rates, the destructive Single Event Effect (SEE) Linear Energy Transfer (LET) threshold, and the total absorption rates of the programmable logic device may correspond to withstanding (e.g., tolerating particle effects of) radiation amounts higher than that a Wi-Fi chip is able to withstand while remaining operational.

As such, in some embodiments, the I/O interfaces 56, the communication manager 58, or both may be radiation hardened based on the non-destructive Single Event Functional Interrupt (SEFI) rates, the destructive Single Event Effect (SEE) Linear Energy Transfer (LET) threshold, and the total absorption rates described above, or any combination thereof, among other possibilities. Accordingly, the computing and radio device 24 may communicate data in terrestrial environment and during space exploration activities.

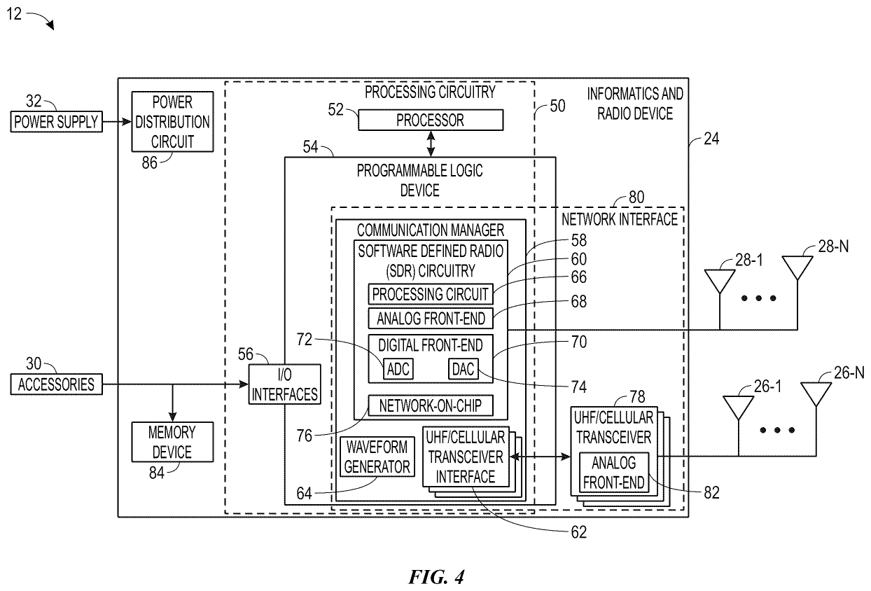

FIG. 4 is a block diagram of the electronic system 12 of the spacesuit 10 and/or the space exploration vehicle 38 discussed above including the computing and radio device 24, the antennas 26 and 28, a power supply 32, and the accessories 30, according to embodiments of the present disclosure. Although specific components are shown in FIG. 4, it should be appreciated that in some embodiments consistent with the teachings here, the electronic system 12 may include additional components, omit one or more of the depicted components, or both.

As discussed above, the computing and radio device 24 may include the processing circuitry 50, the UHF/cellular transceivers 78, the memory device 84, and the power distribution circuit 86. The processing circuitry 50 may include the processor 52 and the programmable logic device 54. The processor 52 may be coupled to the programmable logic device 54.

The programmable logic device 54 may include the communication manager 58 including the SDR 60 and the UHF/cellular transceiver interface 62. As mentioned above, the communication manager 58 and the UHF/cellular transceivers 78 may form the network interface 80. The network interface 80 may transmit and/or receive signals via the antennas 26 and/or 28. In different embodiments, the electronic system 12 may include a different number of Wi-Fi antennas 28-1 through 28-N and/or UHF and/or cellular antennas 26-1 through UHF and/or cellular antennas 26-N. The programmable logic device 54 may include at least a portion of the I/O interfaces 56. Accordingly, the programmable logic device 54 may route data and/or signals between antennas 26 and 28, the accessories 30, the processor 52, and the memory device 84.

In some cases, the network interface 80 may form a multiple-input multiple-output (MIMO) circuit with the Wi-Fi antennas 28-1 through 28-N and/or the UHF and/or cellular antennas 26-1 through UHF and/or cellular antennas 26-N. For example, the communication manager 58 may receive and/or transmit signals over multiple communication channels having different frequency ranges. The frequency channels may include multiple frequency ranges within the Wi-Fi frequency ranges, the cellular frequency range, the UHF frequency range, among other possibilities.

In the depicted embodiment, a portion of the I/O interfaces 56 may be implemented on the fabric of the programmable logic device 54. In different embodiments, the programmable logic device 54 may include (e.g., implement) different portions of the I/O interfaces 56 based on the configuration bitstream upon activation and/or receiving the instructions. In some embodiments, at least a portion of the I/O interfaces 56 may be disposed on circuitry outside the programmable logic device 54. Alternatively, the programmable logic device 54 may include the entirety of the I/O interfaces 56 implemented thereon. The I/O interfaces 56 may be coupled to the accessories 30 and the memory device 84.

The I/O interfaces 56 may couple to the accessories 30 via accessory ports (e.g., peripheries). The accessory ports may include and/or support implementation of peripheral component interconnect express (PCIe), Universal Serial Bus (USB), Low Voltage Differential Signaling (LVDS), Integrated Inter-IC Sound Bus (I2S), Serial Peripheral Interface (SPI), reduced gigabit media independent interface (RGMII), serial digital interface (SDI), hardline wire communication, optical fiber, and so on. As such, the I/O interfaces 56 may include circuitry to adjust the data and/or signals based on a protocol used by the accessory ports to facilitate data communication between the programmable logic device 54, the processor 52, and the accessories 30. For example, the I/O interfaces 56 may convert between multiple formats of data packets and/or adjust a frequency of data and/or data packets output from and/or input to the programmable logic device 54, the processor 52, and the accessories 30. In specific cases, converting between multiple formats of data packets is based on data protocols used by the accessories 30, a Wi-Fi communication protocol, a size of the data packets used by the data protocols of the accessories 30 and/or a Wi-Fi communication protocol, among other possibilities.

As discussed above, the SDR 60 may include the processing circuit 66, the analog front-end 68, the digital front-end 70, and the NOC 76. The SDR 60 may couple to the Wi-Fi antennas 28 to communicate Wi-Fi signals based on the Wi-Fi standards. The analog front-end 68 may receive and condition received Wi-Fi signals of the Wi-Fi antennas 28 from processing by the digital front-end 70 and/or the processing circuit 66. The analog front-end 68 may receive and condition transmission Wi-Fi signals received from the digital front-end 70 and/or the processing circuit 66 for transmission by the Wi-Fi antennas 28.

In some embodiments, the analog front-end 68 may match the input/output impedance of the Wi-Fi antennas 28 with the input/output impedance of the processing circuit 66 and/or the digital front-end 70. The analog front-end 68 may adjust a gain and/or frequency of Wi-Fi signals for transmission by the Wi-Fi antennas 28. Alternatively or additionally, the analog front-end 68 may adjust a gain and/or frequency of Wi-Fi signals for reception and processing by the processing circuit 66 and/or the digital front-end 70, the processor 52, or any combination thereof.

The NOC 76 may route data and/or signals between the I/O interfaces 56, the processing circuit 66, the analog front-end 68, the digital front-end 70, the processor 52, the UHF/cellular transceiver interface 62, and/or the antennas 26 and/or 28. The UHF/cellular transceiver interfaces 62 may communicate data and/or signals with the UHF/cellular transceivers 78. For example, the analog front-end 82 of the UHF/cellular transceivers 78 may generate and output reception data to the UHF/cellular transceiver interfaces 62 for processing by the programmable logic device 54 and/or the processor 52.

The analog front-end 82 may generate and output the reception data based on inputting received UHF and/or cellular signals, among other possible signals, from the UHF and/or cellular antennas 26. The analog front-end 82 may generate and output transmission UHF and/or cellular signals to the UHF and/or cellular antennas 26 for transmission. The analog front-end 82 may output the transmission UHF and/or cellular signals based on inputting received UHF and/or cellular signals, among other possible signals, from the UHF/cellular transceiver interfaces 62.

As mentioned above, the I/O interfaces 56 may be coupled to the accessories 30 and the memory device 84. The accessories 30 may include any viable component of the spacesuit 10 and/or the space exploration vehicle 38 discussed above, as will be appreciated. The computing and radio device 24 may include the power distribution circuit 86. The power distribution circuit 86 may be coupled to a power supply 32 of the electronic system 12. The power supply 32 may provide electrical power to the power distribution circuit 86. The power distribution circuit 86 may be coupled to the processor 52, the programmable logic device 54, the UHF/cellular transceivers 78, and/or the memory device 84, among other things. Accordingly, the power distribution circuit 86 may distribute the electrical power to the components of the computing and radio device 24.

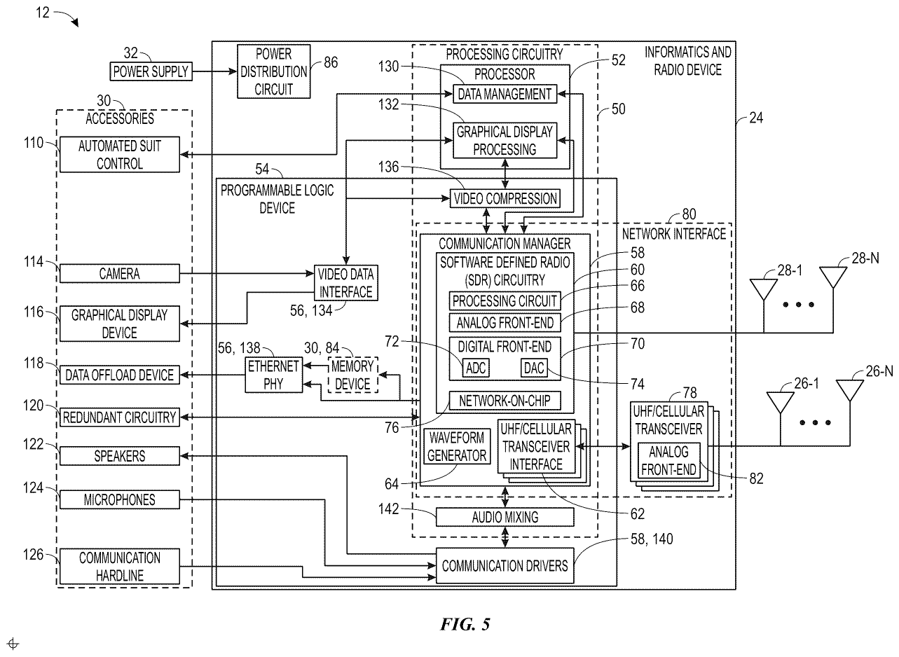

FIG. 5 is a block diagram of the electronic system 12 of the spacesuit 10 and/or the space exploration vehicle 38 including multiple processing blocks, accessories, and communication interfaces and drivers, according to embodiments of the present disclosure. In the depicted embodiment, the electronic system 12 may include the computing and radio device 24, the antennas 26 and 28, the power supply 32, and the accessories 30. Although specific components are shown in FIG. 5, it should be appreciated that in different embodiments, the electronic system 12 may include additional components, omit one or more of the depicted components, or both.

The accessories 30 may include an automated suit control 110, cameras 114, a graphical display device 116, a data offload device 118, redundant circuitry 120, speakers 122, microphones 124, and a communication hardline 126. In some embodiments, the accessories 30 may include additional components, such as oxygen regulators/controllers, thermal controllers, batteries, and/or other components not shown for simplicity. In some embodiments, one or more of the accessories 30 mentioned above may be omitted.

In some cases, the automated suit control 110 may include circuitry to control an oxygen pump of the spacesuit 10. For example, the automated suit control 110 may be coupled to an oxygen tank of the spacesuit 10. In addition, the automated suit control 110 may be coupled to the processor 52. The automated suit control 110 may input (e.g., receive) and/or output (e.g., transmit) instructions to control the oxygen pump and therefore an amount of oxygen inside the helmet 14 of the spacesuit 10 discussed above with respect to FIG. 1.

In some embodiments, the data management 130 of the processor 52 may generate and/or output instructions to the automated suit control 110 based on received data from the communication manager 58 of the programmable logic device 54. Alternatively or additionally, the data management 130 may generate and/or output instructions to the communication manager 58 based on received data from the automated suit control 110. For example, the communication manager 58 may transmit and/or receive data associated with the automated suit control 110 by the antennas 26 and/or 28.

The cameras 114 may output captured video data to a video data interface 134 of the I/O interfaces 56. In some cases, the cameras 114 may output captured video data in near-real time with respect to capture of live content. In the depicted embodiment, the programmable logic device 54 may include the video data interface 134. The video data interface 134 may adjust the captured video data and output the adjusted captured video data. For example, the video data interface 134 may output the adjusted captured video data to a graphical display processing 132 of the processor 52, a video compression block 136 of the programmable logic device 54, or both.

The graphical display processing 132 may process the adjusted captured video data for storage and/or transmission. The video compression block 136 may compress the adjusted captured video data, for example, to reduce a size of the adjusted captured video data. In some embodiments, the graphical display processing 132 may receive the compressed adjusted captured video data from the video compression block 136 for processing. Alternatively or additionally, the video compression block 136 may receive the processed adjusted captured video data from the graphical display processing 132 for compression.

The graphical display processing 132, the video compression block 136, or both, may output the compressed and/or processed adjusted captured video data to the communication manager 58. In different cases, the communication manager 58 may route the adjusted captured video data to the I/O interfaces 56, the SDR 60, and/or the UHF/cellular transceiver interface 62. For example, the communication manager 58 may route the adjusted captured video data to the SDR 60 for transmission by the Wi-Fi antennas 28. Alternatively or additionally, the communication manager 58 may route the adjusted captured video data to the UHF/cellular transceiver interface 62 for transmission by the UHF and/or cellular antennas 26. In specific cases, the antennas 26 and/or 28 may transmit the adjusted captured video data in near-real time with respect to the capture of the live content.

In some embodiments, the communication manager 58 may route the adjusted captured video data to the graphical display device 116 via the graphical display processing 132, the video compression block 136, and/or the video data interface 134. The graphical display device 116 may include circuitry to display the adjusted captured video data. The received signals, including the Wi-Fi received signals and the UHF/cellular received signals, may include received video data. For example, Wi-Fi antennas 28 and/or the UHF and/or cellular antennas 26 may input (e.g., receive) and output (e.g., transmit) the received video data. As such, in some cases, the communication manager 58 may route the received video data of the received signals to the graphical display device 116 via the graphical display processing 132, the video compression block 136, and/or the video data interface 134.

The data offload device 118 may include a storage device, among other things. For example, the I/O interfaces 56 of the programmable logic device 54 may include an Ethernet physical layer (PHY) 138 coupled to the data offload device 118. The communication manager 58 may output the received data (e.g., the data packets) based on the received signals by the antennas 26 and 28 to the data offload device 118 for storage. For example, the data offload device 118 may include volatile and/or non-volatile storage.

The memory device 84 may be a part of the programmable logic device 54, the accessories 30, or both. Additionally or alternatively, the memory device 84 may output a portion of the stored data for storage on the data offload device 118 via the Ethernet PHY 138. Yet additionally or alternatively, the communication manager 58, the memory device 84, or both, among other things, may output additional data for storage on the data offload device 118 including the captured video data (e.g., compressed, processed, and/or adjusted captured video data).

The redundant circuitry 120 may include any viable circuitry to redundantly perform at least a portion of operations of the computing and radio device 24. In some cases, the redundant circuitry 120 may improve robustness or reduce an error rate of the electronic system 12. For example, the redundant circuitry 120 may include a second computing and radio device, at least partially similar to the computing and radio device 24 described here. Alternatively or additionally, the redundant circuitry 120 may include different circuitry. In any case, the redundant circuitry 120 and the programmable logic device 54 may compare at least a portion of the processed and/or received data. The redundant circuitry 120 and/or the programmable logic device 54 may determine whether the compared data match to improve robustness of the electronic system 12.

The speakers 122 may receive audio signals from communication drivers 140 of the I/O interfaces 56. For example, the received Wi-Fi signals and/or the received UHF/cellular received signals may include the audio signals. Audio drivers of the audio signals may include voice activation, volume control, and mute functions to generate analog audio waves. The speakers 122 may generate audio based on receiving the analog audio signals. In different cases, the audio data signals may correspond to generating audio signals by the speakers 122 having frequencies within different frequency ranges. The microphones 124 and the communication hardline 126 may output audio signals to the communication drivers 140.

The communication drivers 140 may include circuitry to receive, adjust, and output audio signals between the speakers 122, the microphones 124, the communication hardline 126, and an audio mixing block 142. The audio mixing block 142 may include circuitry to generate audio signals based on receiving audio data from the communication manager 58 and/or the microphones 124 and communication hardline 126 via the communication drivers 140. The audio mixing block 142 may include circuitry to generate audio data based on receiving audio signals from the communication manager 58 and/or the microphones 124 and communication hardline 126 via the communication drivers 140. Although the audio mixing block 142 is depicted as implemented by the programmable logic device 54, alternatively or additionally, the audio mixing block 142 may be disposed on separate circuitry outside the programmable logic device 54.

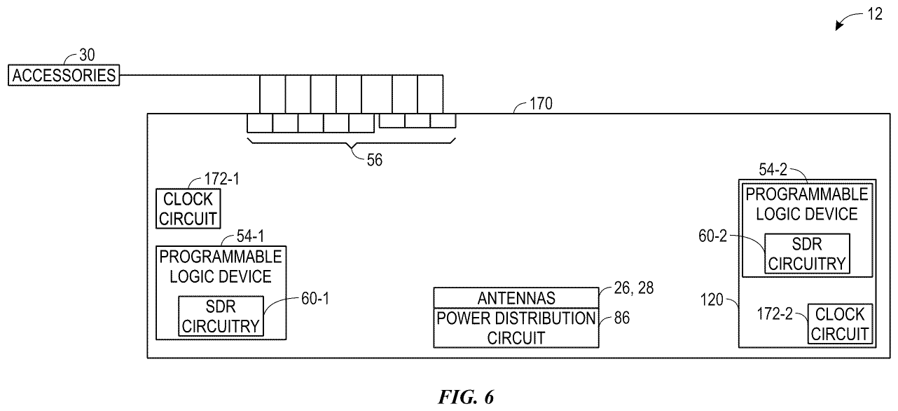

FIG. 6 is a block diagram of a carrier circuit board 170 (e.g., a mezzanine board) of the spacesuit 10 and/or the space exploration vehicle 38 discussed above, according to embodiments of the present disclosure. The electronic system 12 may include the carrier circuit board 170 having the computing and radio device 24 disposed thereon. The carrier circuit board 170 may be coupled to the accessories 30 via the I/O interfaces 56. As mentioned above, in different embodiments, the I/O interfaces 56 may be disposed on the programmable logic device 54, disposed on circuitry outside the programmable logic device 54, or any combination of both. A portion of or the entirety of the carrier circuit board 170 may be radiation hardened to withstand (e.g., tolerate particle effects of) a predetermined amount of radiation. For example, as discussed above, the programmable logic device 54 including the SDR 60 discussed above may be radiation hardened to withstand (e.g., tolerate particle effects of) a predetermined amount of radiation.

The carrier circuit board 170 may include a first programmable logic device 54-1 including first SDR 60-1. The carrier circuit board 170 may also include the redundant circuitry 120 including a second programmable logic device 54-2 having second SDR 60-2. As mentioned above, the redundant circuitry 120 and the programmable logic device 54 may compare at least a portion of the processed and/or received data of the antennas 26 and 28. The redundant circuitry 120 and/or the programmable logic device 54 may determine whether the compared data match to improve robustness of the electronic system 12. As such, in some cases, the redundant circuitry 120 may improve robustness or reduce an error rate of the electronic system 12.

The carrier circuit board 170 may include the antennas 26 and 28, the power distribution circuit 86 and clock generator circuits 172-1 and 172-2. The clock generator circuit 172-1 may generate and output a first clock signal to the first programmable logic device 54-1 and the clock generator circuit 172-2 may generate and output a second clock signal to the second programmable logic device 54-2. In some cases, the first clock signal and the second clock signal may have an equal or approximately equal oscillation frequency (e.g., the baseband frequency rate). As such, in some cases, the first programmable logic device 54-1 and the second programmable logic device 54-2 may operate based on separately generated clock signals for improved comparison, detection, and correction of erroneous data.

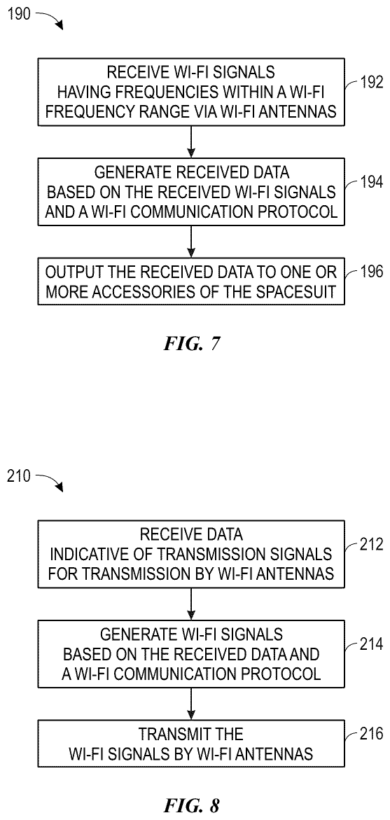

FIG. 7 is a process 190 for reception and processing of Wi-Fi signals by the Wi-Fi antennas 28 and the programmable logic device 54 of the spacesuit 10 and/or the space exploration vehicle 38. The SDR 60 of the programmable logic device 54 may perform the operations of the process blocks discussed below. Although the process 190 is described in a particular order with particular process blocks, it should be appreciated that, in alternative or additional embodiments, the process 190 may include different process blocks and/or may be performed in a different order. In some embodiments, a non-transitory computer readable media, such as the memory device 84 discussed above, may store instructions that may cause the processor 52, the programmable logic device 54, or both to perform the operations of the process blocks discussed below.

At block 192, the SDR 60 receives Wi-Fi signals having frequencies within a Wi-Fi frequency range. The SDR 60 may receive the Wi-Fi signals via the Wi-Fi antennas 28. As mentioned above, the Wi-Fi frequency range may be Wi-Fi frequency range of 0.5-2 GHz, 0.7-2.4 GHz, 2-4 GHz, 2.4-5 GHz, 2.5-6 GHz, 6-60 GHz, and so on. It should be appreciated that the SDR 60 may receive multiple Wi-Fi signals having frequencies within the same, approximately the same, or different communication channels (e.g., sub-frequency ranges) of the Wi-Fi frequency range. In such cases, the SDR 60 may receive multiple inputs.

At block 194, the SDR 60 generates received data (e.g., the Wi-Fi data) based on the received Wi-Fi signals and a Wi-Fi communication protocol. The received data may include and/or correspond to received instructions, audio, and/or video, among other things. The Wi-Fi communication protocol may include any viable data protocol or standard including, but not limited to, IEEE 802 standards for Wi-Fi communications. In some cases, the SDR 60 may also adjust a frequency of the received Wi-Fi signals to generate the received data. For example, the SDR 60 may store and retrieve data in a buffer on the memory device 84 discussed above to down-convert the frequency of the received data to a baseband frequency of the programmable logic device 54.

At block 196, the SDR 60 may output the received data to one or more of the accessories 30 of the spacesuit 10 and/or the space exploration vehicle 38 discussed above. The SDR 60 may output the received data to any combination of the processor 52, the memory device 84, the automated suit control 110, the cameras 114, the graphical display device 116, the data offload device 118, the redundant circuitry 120, the speakers 122, the microphones 124, and the communication hardline 126. As discussed above, the received data may include various control instructions, video data, audio data, among other things.

FIG. 8 is a process 210 for processing and transmission of Wi-Fi signals by the programmable logic device 54 and the Wi-Fi antennas 28 of the spacesuit 10 and/or the space exploration vehicle 38. The SDR 60 of the programmable logic device 54 may perform the operations of the process blocks discussed below. Although the process 210 is described in a particular order with particular process blocks, it should be appreciated that in alternative or additional embodiments, the process 210 may include different process blocks and/or may be performed in a different order. In some embodiments, a non-transitory computer readable media, such as the memory device 84 discussed above, may store instructions that may be used by the processor 52, the programmable logic device 54, or both to perform the operations of the process blocks discussed below.

At block 212, the SDR 60 receives data (e.g., the Wi-Fi data) indicative of transmission signals for transmission by the Wi-Fi antennas 28. The SDR 60 may receive transmission data from any combination of the processor 52, the memory device 84, the automated suit control 110, the cameras 114, the graphical display device 116, the data offload device 118, the redundant circuitry 120, the speakers 122, the microphones 124, and the communication hardline 126. The transmission data may include various control instructions, video data, audio data, among other things.

At block 214, the SDR 60 generates Wi-Fi signals based on the received data and a Wi-Fi communication protocol. The Wi-Fi communication protocol may include any viable data protocol or standard including, but not limited to, IEEE 802 standards for Wi-Fi communications. In some cases, the SDR 60 may also adjust a frequency of the Wi-Fi signals for transmission. For example, the SDR 60 may up-convert the frequency of the transmission data from a baseband frequency of the programmable logic device 54 to a transmission frequency by the Wi-Fi antennas 28. The transmission frequency may be within the Wi-Fi frequency range.

At block 216, the SDR 60 transmits the Wi-Fi signals by the Wi-Fi antennas 28. In some cases, the SDR 60 may transmit multiple outputs. For example, the SDR 60 may transmit multiple Wi-Fi signals having frequencies within the same, approximately the same, or different communication channels (e.g., sub-frequency ranges) of the Wi-Fi frequency range.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed here are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

1. A computing and radio device, comprising:
an input/output (I/O) interface configured to couple to an accessory of a spacesuit or a space exploration vehicle, wherein the I/O interface is configured to convert a data packet format of first accessory data received from the accessory; and
a programmable logic device being radiation hardened to withstand up to a first amount of radiation greater than a second amount of radiation that a Wi-Fi chip is able to withstand while remaining operational, wherein the programmable logic device is configured to couple to the accessory of the spacesuit or the space exploration vehicle via the I/O interface, wherein the programmable logic device is configured to output the first accessory data, wherein the programmable logic device implements a Wi-Fi processing circuit, a Wi-Fi analog front-end, and a Wi-Fi digital front-end of Wi-Fi software-defined radio (SDR), wherein the Wi-Fi analog front-end is configured to receive first Wi-Fi signals received by a Wi-Fi antenna, wherein the Wi-Fi digital front-end is configured to generate first Wi-Fi data based on the first Wi-Fi signals, and wherein the Wi-Fi processing circuit is configured to generate and output the first accessory data based on the first Wi-Fi data.

2. The computing and radio device of claim 1, wherein:
the programmable logic device is configured to receive second accessory data;
the I/O interface is configured to convert a format of data packets of the second accessory data output from the accessory;
the Wi-Fi processing circuit is configured to generate second Wi-Fi data based on the second accessory data;
the Wi-Fi digital front-end is configured to generate second Wi-Fi signals based on the second Wi-Fi data; and
the Wi-Fi analog front-end is configured to transmit the second Wi-Fi signals by the Wi-Fi antenna.

3. The computing and radio device of claim 1, wherein the programmable logic device comprises a field-programmable gate array, and the field programmable gate array is configured to implement the Wi-Fi SDR.

4. The computing and radio device of claim 1, wherein the first amount of radiation corresponds to a first threshold amount of non-destructive Single Event Functional Interrupt (SEFI) rates, a second threshold amount of destructive Single Event Effect (SEE) Linear Energy Transfer (LET), a third threshold amount of total absorption rates, or any combination thereof.

5. The computing and radio device of claim 4, wherein the first threshold amount corresponds to 0.01, 0.001, 0.0003, 0.00001, 0.000005, 0.000001, 0.0000005, or 0.0000001 of SEFI rates, the second threshold amount corresponds to 10 mega-electronvolts energy (MeV) per centimeters square unit area (cm²) per milligram mass (mg), 25 MeVcm²mg, 31 MeVcm²mg, 37 MeVcm²mg, 52 MeVcm²mg, 60 MeVcm²mg, or 70 MeVcm²mg of SEE LET, the third threshold amount corresponds to 0.5 Kilo radiation absorbed dose (Krads), 1.1 Krads, 2 Krads, 2.23 Krads, 2.3 Krads, 2.5 Krads, 3 Krads, 4.6 Krads, or 7.9 Krads of the total absorption rates at each time, 0.5 Krads, 1.1 Krads, 15 Krads, 22.4 Krads, 27.8 Krads, 31.132 Krads, 37.12 Krads, 43.56 Krads, 52.87 Krads over a time period, or any combination thereof.

6. The computing and radio device of claim 1, wherein the programmable logic device is configured to implement at least a portion of the I/O interface.

7. The computing and radio device of claim 1, wherein the I/O interface comprises an Ethernet physical layer, a video data interface, an audio communication driver, or any combination thereof.

8. The computing and radio device of claim 1, wherein the accessory comprises a camera, a graphical display device, a data offload device, redundant circuitry, a speaker, a microphone, a communication hardline, or any combination thereof.

9. The computing and radio device of claim 1, wherein the programmable logic device is configured to implement or couple to an ultra-high frequency (UHF) transceiver interface, a cellular transceiver interface, or any combination thereof.

10. An electronic system of a spacesuit or a space exploration vehicle comprising:
an accessory configured to communicate accessory data;
an I/O interface configured to couple to the accessory, wherein the I/O interface is configured to convert a format of data packets of the accessory data and Wi-Fi data based on a Wi-Fi communication protocol;
a programmable logic device configured to withstand up to a first amount of radiation greater than a second amount of radiation that a Wi-Fi chip is able to withstand while remaining operational, wherein the programmable logic device is configured to couple to the accessory via the I/O interface, wherein the I/O interface is configured to communicate the accessory data with the accessory and communicate the Wi-Fi data with the programmable logic device, wherein the programmable logic device is configured to implement Wi-Fi software-defined radio (SDR), wherein the Wi-Fi SDR is configured to generate Wi-Fi data and Wi-Fi signals based on the Wi-Fi communication protocol; and
a Wi-Fi antenna coupled to the Wi-Fi SDR, wherein the Wi-Fi antenna is configured to output received Wi-Fi signals to and transmit Wi-Fi signals from the Wi-Fi SDR.

11. The electronic system of claim 10, wherein the Wi-Fi SDR comprises a Wi-Fi processing circuit, a Wi-Fi digital front-end, and a Wi-Fi analog front-end, wherein the Wi-Fi processing circuit is configured to generate the Wi-Fi data based on the accessory data, wherein the Wi-Fi digital front-end is configured to generate the Wi-Fi signals based on the Wi-Fi data, and wherein the Wi-Fi analog front-end is configured to adjust the Wi-Fi signals for transmission by the Wi-Fi antenna.

12. The electronic system of claim 10, wherein the Wi-Fi SDR is configured to generate and output the Wi-Fi data to the accessory based on Wi-Fi signals received by the Wi-Fi antenna, wherein the I/O interface is configured to generate the accessory data based on converting the format of the data packets of the Wi-Fi data.

13. The electronic system of claim 10, wherein the accessory comprises a camera, a graphical display device, a data offload device, redundant circuitry, a speaker, a microphone, a communication hardline, or any combination thereof, and wherein the accessory data correspond to instructions, video data, audio data, or any combination thereof.

14. The electronic system of claim 10, wherein the first amount of radiation corresponds to a first threshold amount of non-destructive Single Event Functional Interrupt (SEFI) rates, a second threshold amount of destructive Single Event Effect (SEE) Linear Energy Transfer (LET), a third threshold amount of total absorption rates, or any combination thereof.

15. Tangible, non-transitory, computer-readable media storing instructions that, when executed by a programmable logic device disposed on a spacesuit or a space exploration vehicle, are configured to cause the programmable logic device to:
implement a Wi-Fi software-defined radio (SDR), wherein the Wi-Fi SDR implemented on the programmable logic device is configured to withstand up to a first amount of radiation greater than a second amount of radiation up to which a Wi-Fi chip is able to withstand while remaining operational;
receive Wi-Fi data;
generate Wi-Fi signals based on the Wi-Fi data and a Wi-Fi communication protocol; and
transmit the Wi-Fi signals by a Wi-Fi antenna.

16. The tangible, non-transitory, computer-readable media of claim 15, wherein the Wi-Fi SDR comprises:
a Wi-Fi processing circuit configured to generate the Wi-Fi data,
a Wi-Fi digital front-end configured to generate the Wi-Fi signals based on the Wi-Fi data, and
a Wi-Fi analog front-end configured to adjust the Wi-Fi signals for transmission by the Wi-Fi antenna.

17. The tangible, non-transitory, computer-readable media of claim 15, wherein the instructions are configured to cause the programmable logic device to:
receive second Wi-Fi signals having frequencies within a Wi-Fi frequency range;
generate second Wi-Fi data based on the second Wi-Fi signals and the Wi-Fi communication protocol; and
output the second Wi-Fi data to one or more accessories of the spacesuit or the space exploration vehicle.

18. The tangible, non-transitory, computer-readable media of claim 15, wherein the instructions are configured to cause the programmable logic device to communicate with one or more accessories of the spacesuit or the space exploration vehicle using the Wi-Fi signals.

19. The tangible, non-transitory, computer-readable media of claim 15, wherein the instructions are configured to cause the programmable logic device to communicate with one or more other electronic devices using the Wi-Fi signals.

20. The tangible, non-transitory, computer-readable media of claim 15, wherein the Wi-Fi communication protocol corresponds to a communication protocol defined by Institute of Electrical and Electronics Engineers (IEEE) 802 standards.
